(19) United States
(12) Patent Application Publication
(10) Pub. No.: US 2006/0144673 A1
(43) Pub. Date: Jul. 6, 2006

(54) Method and apparatus for conveying workpieces, and working machine

(75) Inventor: Tatsuo Joji, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: TDK Corporation, Tokyo (JP)

(21) Appl. No.: 11/290,823

(22) Filed: Dec. 1, 2005

(30) Foreign Application Priority Data
Jan. 6, 2005 (JP) 2005-001909

(51) Int. Cl. B23Q 7/00

(52) U.S. Cl. 198/339.1

(57) ABSTRACT

A method of conveying workpieces comprises the steps of feeding at least one workpiece to an inlet side of a conveyance path, by a first pusher, pushing the workpiece or workpieces from the rear side in the advancing direction of the workpiece, and by a second pusher, pushing the workpiece or workpieces from the rear side in the advancing direction of the workpiece. While either of the first or the second pusher moves forward to convey the workpiece or workpieces, the other pusher retreats from and returns to the position behind of the workpiece or workpieces newly fed to the inlet side.

### BACKGROUND OF THE INVENTION

1. Field of the Invention

The present invention relates to a method and an apparatus suitable for conveying plate workpieces in various working machines and relates to a working machine using the apparatus.

2. Description of the Prior Art

When transferring workpieces to a working machine for polishing, grinding or the like, with the working machine, loads to the workpieces so heavy that conveyance with a general conveyor (belt conveyor, roller conveyor, etc.) is difficult. However, continuous throw of workpieces (continuous feeding of workpieces) is desirable for production capability. Therefore, a mechanism which conveys a workpiece 1 to a polishing machine having a rotary grindstone 10 as shown in FIG. 8A by using rubber rollers 11 as nip rollers has been conventionally employed. The workpiece 1 is for example a sintered ferrite body (unmagnetized) to be a ferrite magnet or the like. In the mechanism, the workpiece 1 manually fed is placed between the nip rollers 11 and transferred to send the workpiece 1 to the working position of the grindstone 10.

In the case of nip rollers, a conveyance area A (the area where workpieces are continuously transferred in condition that a workpiece behind pushes former one) exists between the rubber rollers 11 and the grindstone 10. The same situation may be happen when a pusher pushes an increased number of workpieces at once in an advancing direction.

In particular, when a width W and a length L of a workpiece has a relationship W>L as shown in FIG. 8B, the workpieces conveyed between nip rollers and a rotary grindstone are aligned in inclined position (the condition where the width direction of a workpiece is not perpendicular to a conveying direction of the workpiece), resulting in drawbacks such as faulty conveyance and inclined working.

On the other hand, if a structure (batch tact feed) in which a workpiece is pushed by a pusher in an advancing direction one by one is employed, conveyance of the workpieces is unaffected by a cumulative deformation and dimension error, so that it is possible to convey the workpieces in stable attitudes. But, the conveyance capacity tends to be declined.

Examples of mechanisms for conveying articles to working machines are described in Japanese Utility Model Application Laid-Open No. 05-082927, Japanese Patent Application Laid-Open No. 10-074777, and Japanese Patent Application Laid-Open No. 2000-177714.

Japanese Utility Model Application Laid-Open No. 05-082927 is an example of a conveying system for feeding workpieces, which is longer in a conveyance direction to a working machine. The system is configured that a pusher for pushing a workpiece is driven by a ball screw and a motor at the time of advancing and by wire at the time of retreating to shorten loss time resulting from faster retreat. However, when workpieces whose length L in the conveying direction is short, the workpieces are continuously transferred in condition that a workpiece behind pushes former one as shown in FIG. 8B. Therefore inclination of workpieces occurs, resulting in the problem of the workpiece being conveyed in an inclined state.

Japanese Utility Model Application Laid-Open No. 05-082927 does not provide any suggestion on how to solve this problem. Also, there is a single pusher, and there is a limit to the reduction in loss time when retracting.

Japanese Patent Application Laid-Open No. 10-074777 is an example of an IC on a lead frame conveyed to a bonding machine. In this case it is presupposed that the lead frame is gripped by feeding claws to be conveyed, and by providing a sensor at a position where the lead frame arrives at, waste is eliminated from the conveying operation. However, just like Japanese Utility Model Application Laid-Open No. 05-082927, the articles to be conveyed are rectangular lead frames (long in the direction of conveyance), and Japanese Patent Application Laid-Open No. 10-074777 does not suggest any technique for solving the problem when the workpiece is short in the direction of conveyance.

Japanese Patent Application Laid-Open No. 2000-177714 is an example of an external box conveyed from a waiting position to a prescribed feeding-out position. There are two conveyor systems, a first conveyance unit for conveying the external box from a inlet to the waiting position, and a feeding-out unit for feeding out the external box from the waiting position to the feeding-out position. At the feeding-out position a pitch between external boxes is shortened. It is possible to convert variation in the supply of external boxes as articles for conveyance into a fixed pitch. However the mechanism is assumed to convey an external box without any load acting during conveyance, and no technique for solving the problem when a workpiece is short in the direction of conveyance, is suggested.

### SUMMARY OF THE INVENTION

Accordingly, an object of the present invention is to provide a method and an apparatus for conveying workpieces in which conveyance of the workpieces is unaffected by a cumulative deformation and dimension error, so that it is possible to convey the workpieces stably in a nearly continuous throw manner (continuous feeding of workpieces), also possible to increase production efficiency of various type of working machines and to improve the working quality.

Another object of the invention is to provide a working machine with improved grinding or polishing quality, while maintaining productivity near that of continuous throw.

Other objects as well as new features of the invention are described in an embodiment mentioned below.

To achieve the objects described in the above, the invention provides a method of conveying workpieces comprising the steps of: feeding at least one workpiece to an inlet side of a conveyance path, by a first pusher, pushing the workpiece or workpieces from the rear side in the advancing direction of the workpiece, with the first pusher being transferred substantially parallel to the conveyance direction by a first drive means, by a second pusher, pushing the workpiece or workpieces from the rear side in the advancing direction of the workpiece, with the second pusher being transferred substantially parallel to the conveyance direction by a second drive means; wherein, while either of the first or the second pusher moves forward to convey the workpiece or workpieces, the other pusher retreats from and returns to the position behind of the workpiece or workpieces newly fed to the inlet side.

According to the method of conveying workpieces of the invention, a conveyance speed and an acceleration of the first and the second drive means may be individually controlled.

According to the method of conveying workpieces of the invention, the first and the second pushers may push a plurality of workpieces aligned continuously in the conveyance direction.

According to the method of conveying workpieces of the invention, at least one workpiece may be conveyed so that, while both the first and the second pushers are moving forward, the workpiece being pushed by the rear pusher does not come into contact with the forward pusher.

An apparatus for conveying workpieces of the invention, comprises: a first pusher for pushing at least one workpiece fed to an inlet side of a conveyance path from the rear side in the advancing direction of the workpiece; a first drive means for transferring the first pusher substantially parallel to the conveyance direction; a first transfer mechanism for transferring the first pusher to the area where the workpieces are conveyed and the area other than where the workpieces are conveyed; a second pusher for pushing at least one workpiece fed to the inlet side of the conveyance path from the rear side in the advancing direction of the workpieces; a second drive means for transferring the second pusher substantially parallel to the conveying direction; and a second transfer mechanism for transferring the second pusher to the area where the workpieces are conveyed and the area other than where the workpieces are conveyed.

According to the apparatus for conveying workpieces of the invention, the first and the second drive means may include a servomotor or a pulse motor drive.

According to the apparatus for conveying workpieces of the invention, the first and the second drive means may be controlled so that, when the both first and second pushers are moving forward, the workpiece being pushed by the rear pusher does not come into contact with the forward pusher.

A working machine of the invention polishes or grinds workpieces conveyed by the apparatus for conveying workpieces according to the invention.

### BRIEF DESCRIPTION OF THE DRAWINGS

FIG. 1 shows a plan view of the main parts showing an embodiment of the method and the apparatus for conveying workpieces and the working machine in accordance with the present invention.

FIG. 2 shows a plan view of the overall configuration of the embodiment of the present invention.

FIG. 3 shows a front view of the overall configuration of the embodiment.

FIG. 4 shows a side view of the overall configuration of the embodiment.

FIG. 5 shows an enlarged plan view for illustrating the operation of the embodiment.

FIG. 6 shows a cycle time chart for conveying two workpieces in a dual pusher system of the embodiment of the present invention.

FIG. 7 shows a cycle time chart for conveying two workpieces in a single pusher system of the conventional art.

FIG. 8A is a front view of a conventional polishing machine, and FIG. 8B is a plan view of the conveyance of workpieces.

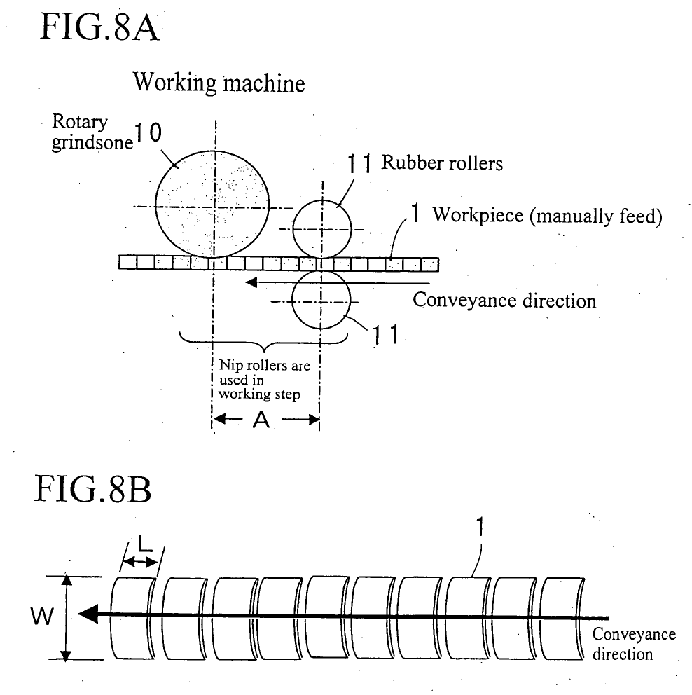

### DETAILED DESCRIPTION OF THE PREFERRED EMBODIMENT

In the following, the method and the apparatus for conveying workpieces and the working machine in accordance with the present invention will be described with reference to the drawings.

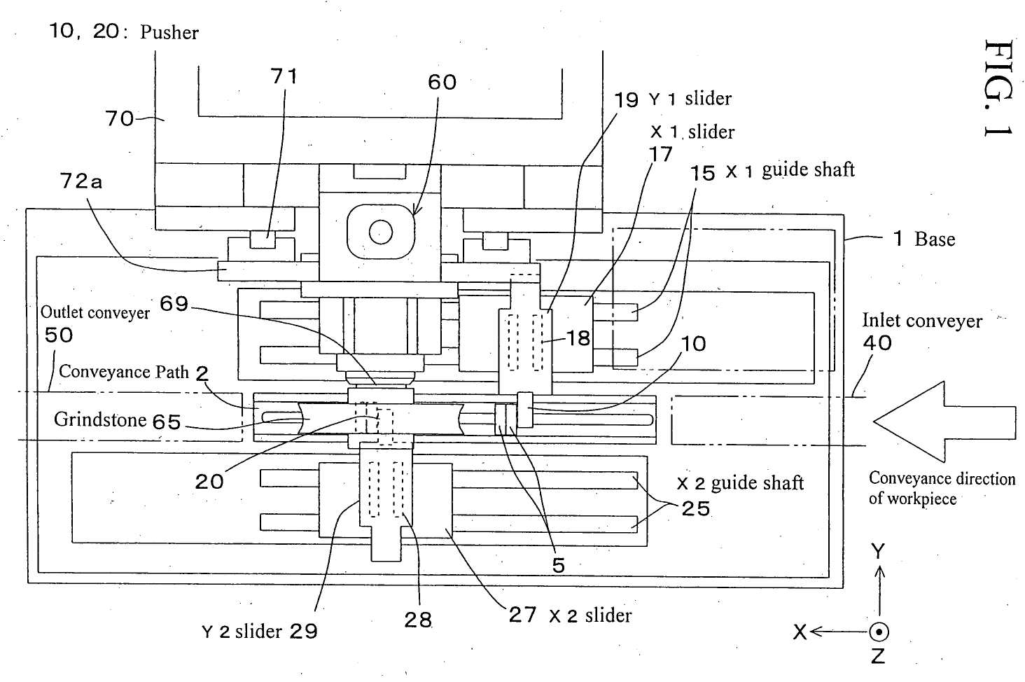

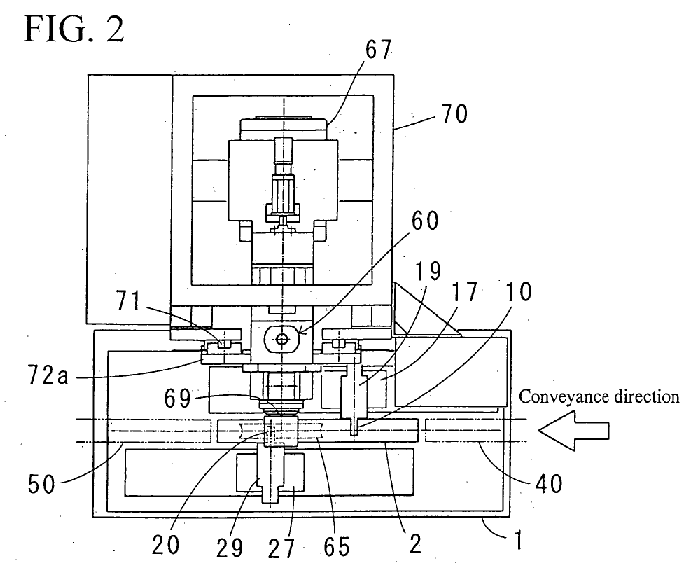

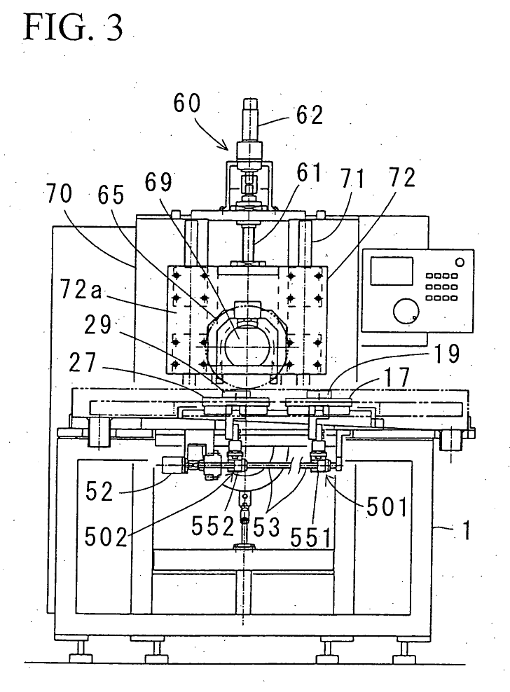

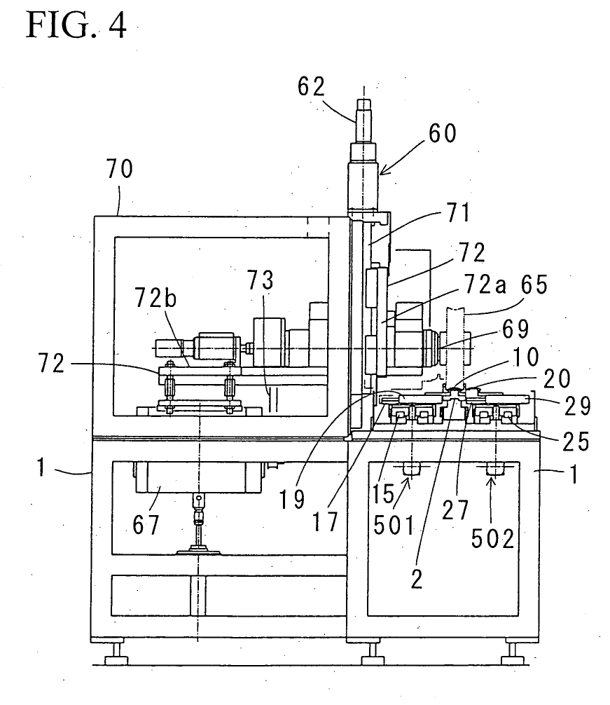

FIGS. 1 to 4 show an embodiment of the method and the apparatus for conveying workpieces and a polishing machine as a working machine using the conveying apparatus in accordance with the present invention. In these drawings, X1 guide shafts 15 and X2 guide shafts 25 are arranged and fixed on a base 1 so that the shafts are parallel or substantially parallel to a workpiece conveyance path 2 (in the X-axis direction on the horizontal plane) with the path 2 lying between the shafts 15 and 25. The X1 guide shafts 15 are mounted with a X1 slider 17 and the X2 guide shafts 25 with a X2 slider 27. Each of the sliders can slide in the X-axis direction. As shown in FIGS. 3 and 4, the X1 slider 17 and X2 slider 27 are driven in the X-axis direction by an X1 drive means 501 and an X2 drive means 502 respectively.

The workpiece conveyance path 2 consists of rails for guiding a workpiece 5 to the advancing direction (X-axis direction) with slidably supporting the workpiece 5. The conveying direction of the workpiece 5 shall be X-axis, the direction that is vertical to the conveying direction of the workpiece 5 in the horizontal plane be Y-axis, and the vertical direction to both X-axis and Y-axis directions be Z-axis. The direction of conveying the workpiece 5 shall be the positive direction of the X-axis, the rightward direction to the conveying direction of the workpiece 5 shall be the positive direction of the Y-axis, and the upward direction be the positive direction of the Z-axis.

A Y1 slider 19 is supported on the X1 slider 17 through Y1 guide shafts 18 so that the Y1 slider 19 can slide in the Y-axis direction. A Y2 slider 29 is supported on the X2 slider 27 through Y2 guide shafts 28 so that the Y2 slider 29 can slide in the Y-axis direction. The Y1 slider 19 is integrally movable in the X-axis direction together with the X1 slider 17 as the slider 17 slides in the X-axis direction. The Y2 slider 29 is integrally movable in the X-axis direction together with the X2 slider 27 as the X2 slider 27 slides in the X-axis direction. The Y1 slider 19 and the Y2 slider 29 are driven in the Y-axis direction by not-shown Y drive means, for example, air cylinders or the like. Each of the Y drive means may be mounted on the X1 slider 17 and the X2 slider 27, or the drive means may be set on the base 1 side corresponding to locations able to actuate the Y1 slider 19 and the Y2 slider 29 (a conveyance start point and a conveyance end point of the pusher).

A first pusher 10 is provided on. (mounted on and fixed to) the Y1 slider 19 as a part of a first transfer mechanism, and is movable inside and outside of the workpiece conveyance path 2 (namely, the conveyance area and the other area) as the Y1 slider 19 slides in the Y-axis direction. The first pusher 10 is also movable in the X-axis direction on the workpiece conveyance path 2 as the X1 slider 17 slides in the X-axis direction. A second pusher 20 is provided on (mounted on and fixed to) the Y2 slider 29 as a part of a second transfer mechanism, and is movable inside and outside of the workpiece conveyance path 2 (namely, the conveyance area and the other area) as the Y2 slider 29 slides in the Y-axis direction. The second pusher 20 is also movable in the X-axis direction as the X2 slider 27 slides in the X-axis direction. That is, the first and second pushers 10, 20 can push forward the workpiece 5 slidably placed on the conveyance path 2 when the pusher 10 or 20 is positioned on the conveyance path 2.

As shown in FIG. 3, the X1 drive means 501 and the X2 drive means 502 have a motor 52 set underside of the base 1 and a ball screw shaft 53 connected to the rotation shaft of the motor 52, respectively. A ball screw nut 551 screwed with the ball screw shaft 53 of the X1 drive means 501 is connected to and fixed on the X1 slider 17. Therefore, the X1 slider 17 moves in the X-axis direction as the ball screw nut 551 moves in the X-axis direction due to the rotation of the ball screw shaft 53. Similarly, a ball screw nut 552 screwed with the ball screw shaft 53 of the X2 drive means 502 is connected to and fixed on the X2 slider 27. Therefore, the X2 slider 27 moves in the X-axis direction as the ball screw nut 552 moves in the X-axis direction due to the rotation of the ball screw shaft 53. As the motor 52, the power source for rotation of the X1 drive means 501 and the X2 drive means 502, a servomotor or a pulse motor is suitable, and, in each drive means, its movement speed and its acceleration may be individually controlled.

As shown in FIG. 4, a Z-axis slide guide 71 is fixed to a fixing frame 70. fixed on the base 1, and a up-and-down frame 72 is supported by the Z-axis slide guide 71 in such a manner that the frame 72 can move upward and downward in the Z-axis direction. A spindle shaft 69 is supported with a bearing on a front vertical part 72a of the up-and-down frame 72, and a spindle motor 67 is attached to a horizontal part 72b of the up-and-down frame 72. Rotational force generated by the spindle motor 67 can be transmitted to the spindle shaft 69 by a wrapping transmission mechanism (other transmission mechanism may be used instead of a wrapping transmission mechanism). For a polishing machine, a rotary grindstone 65 is attached to and fixed on the spindle shaft 69.

A Z drive means 60 for driving the up-and-down frame 72 upward and downward has a motor 62 set in the fixed frame 70 side, a ball screw shaft 61 connected to the rotating shaft of the motor 62 as shown in FIG. 3, and a ball screw nut (not shown) screwed with the ball screw shaft 61. The ball screw nut is fixed on the up-and-down frame 72 side. The grindstone 65 moves up and down as the up-and-down frame 72 moving in the Z-axis direction by drive of the Z drive means 60.

As shown in FIG. 1, an inlet side conveyor 40 is placed at the inlet side of the conveyance of the workpiece conveyance path 2 and an exit-side conveyor 50 is placed at the exit side of the conveyance. Transfer from the inlet conveyor 40 to the inlet side of the workpiece conveyance path 2 can be carried out using a pick and place mechanism, for example. Similarly, transfer from the outlet side of the workpiece conveyance path 2 to the outlet conveyor 50 can be carried out by a pick and place mechanism, for example.

Next, the operation of the embodiment where polishing is done with a rotary grindstone will be described in comparison with a conventional apparatus with a single pusher system.

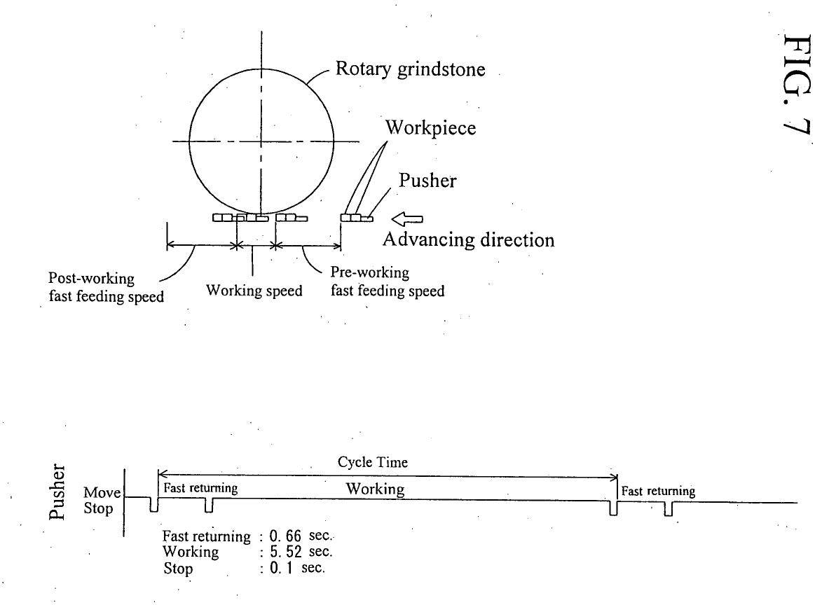

FIG. 7 shows a cycle time chart for conveying two workpieces when a single pusher system conveys two workpieces at once and every two workpieces are worked in batch tact technique. When working of two workpieces is finished, the pusher returns to behind two newly supplied workpieces at the inlet side. Then the two workpieces are pushed to the position to be worked by the rotary grindstone. A stop time is 0.1 seconds, a time for the pusher to fast return is 0.66 seconds, and a working time is 5.52 seconds. A time when the workpieces are not being worked by the rotary grindstone is a loss time. A cycle time per workpiece is 6.38 sec/2=3.19 sec/workpiece. The stop time is a time for the pusher to enter or exit the workpiece conveyance path for the workpiece pushing operation or the returning operation.

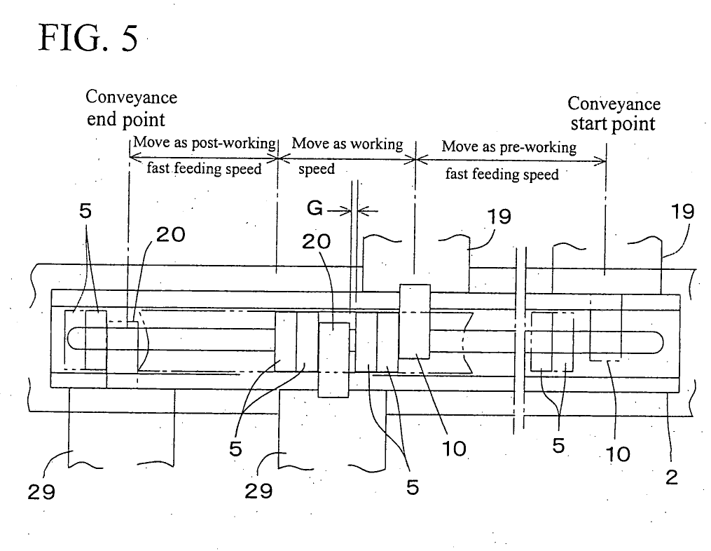

In the preferred embodiment of the present invention, there are two pusher systems. The case where the first pusher 10 and second pusher 20 are used alternately and each pushes two workpieces 5 lined in the conveying direction, as shown in FIG. 5, will be explained. However, it is of course possible for the first pusher 10 and second pusher 20 to push one workpiece 5 or more than two workpieces 5.

First, a height of the rotation axis of the rotary grindstone 65 is adjusted to suit the workpieces 5 to be worked by driving the Z drive means 60. Next, workpieces 5 from the inlet conveyor 40 shown in FIG. 1 are transferred to the inlet side of the workpiece conveyance path 2. In the case of FIG. 5, at this time two workpieces 5 at a time are transferred to the inlet side. At the conveyance start point of the pusher behind the workpieces 5 at the inlet side, the Y1 slider 19 for example is moved in the negative Y direction (pusher projecting direction) by the Y drive means. The first pusher 10 mounted on the Y1 slider 19 is transferred (projected) onto the workpiece conveyance path 2 from off the workpiece conveyance path 2 when the Y1 slider 19 moves in the negative Y direction. At this point in time the first pusher 10 is positioned behind the two workpieces 5 relative to the conveyance direction on the workpiece conveyance path 2.

From this state, the X1 slider 17 is moved in the positive X-axis direction by the X1 drive means 501 as shown in FIG. 3. The Y1 slider 19 supported on the X1 slider 17 also moves in the positive X-axis direction as the X1 slider 17 moves in the positive X-axis direction. Therefore the first pusher 10 pushes and conveys the two workpieces 5 on the workpiece conveyance path 2 from behind relative to the conveying direction. Then the two workpieces 5 are moved in the positive X-axis direction pushed by the first pusher 10, and reach a polish position to be polished by the. grindstone 65. And then polishing of the two workpieces 5 is accomplished as the first pusher 10 advances. Further, the first pusher 10 is moved on the conveyance path 2 to a conveyance end point to feed out the workpiece 5 at outlet side of the conveyance path 2. The workpiece 5 are transferred to the outlet conveyor 50 shown in FIG. 1 when they reach the outlet side.

A speed that the pusher 10 pushes the workpiece 5 from behind on the workpiece conveyance path 2 is high until just before reaching the polish position for polishing by the grindstone 65 {the speed is defined as high conveyance speed (pre-working fast feeding speed)}. However, after the workpieces 5 reach the polish position by the grindstone 65, the pusher 10 decelerates depending upon the intended work (reduces the speed to a low working speed). After the working by the grindstone 65 is finished, the pusher 10 moves at a high conveyance speed (post-working fast feeding speed) to the conveyance end point.

The pusher 10 that has pushed the workpiece 5 to the outlet side of the conveyance path 2 stops at the conveyance end point, and then moves to the positive direction of the Y-axis (pusher returning direction) by drive of the Y drive means. Namely, the pusher 10 is retracted to the outside of the workpiece conveyance path 2. The first pusher 10 moved outside of the workpiece conveyance path 2 returns outside of the path 2 at a high speed (fast returning) from the conveyance end point to the conveyance start point by drive of the X1 drive means 501.

The first pusher 10 returned to the conveyance start point conveys two workpieces newly fed on the workpiece conveyance path 2 in the same operation. By repeating the above-mentioned operation, the first pusher 10 conveys workpieces fed from the inlet side conveyor 40.

The operation of the second pusher 20 is similar to that of the first pusher 10. Namely, by drive of the Y drive means, the second pusher 20 projects over the workpiece conveyance path 2 at the conveyance start point and pushes two workpieces fed from the inlet side conveyor 40 on the workpice conveyance path 2 by drive of the X drive means 502 as shown in FIG. 3. At the conveyance end point, the second pusher 20 is then moved outside of the workpiece conveyance path 2 by drive of the Y drive means and, driven by the X drive means 502, returns to the conveyance start point to convey newly fed workpieces 5 in the same operation. This operation will be repeated.

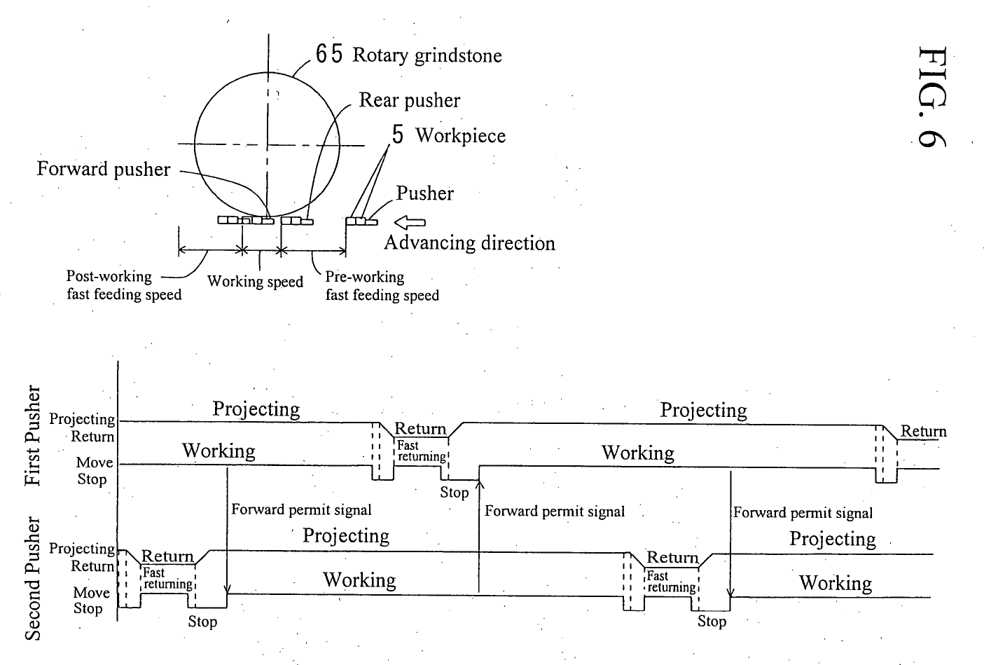

FIG. 6 shows a cycle time chart for feeding two workpieces when two pusher systems are provided and the two workpieces are worked for each cycle. The relationship between the operation of the first pusher 10 and the second pusher 20 will be described using this figure.

During the first pusher 10 moving the workpieces 5 at the low working speed (in other words, during polishing the workpieces 5 pushed by the first pusher 10), the second pusher 20 retreats to return (to make the fast returning) to the position (the conveyance start point) behind of two workpieces sent into the inlet side. At this position, the drive means of the second pusher 20 stops the second pusher 20 until it receives a forward permit signal permitting the pusher 20 to move forward from the drive means of the first pusher 10. When the second pusher 20 receives the forward permit signal permitting forward movement, the pusher 20 moves at high conveyance speed (the pre-working fast feeding speed) until the workpieces 5 reaches just before the polishing position of the grindstone 65. The pusher 20 then moves at the low working speed in working area under the grindstone 65 and moves again at high conveyance speed (the post-working fast feeding speed) after the work finishes.

The reason of the second pusher 20 stopping until receiving the forward permit signal is that there is a risk of the leading workpiece 5 pushed by the pusher 20 crashing with the first pusher 10 moving at the low working speed if the second pusher 20 immediately begins to move forward at high speed (the pre-working fast feeding speed) after its fast returning. The crash may cause great deterioration of working accuracy. To avoid the crash, for example, the forward permit signal permitting advancing movement is transmitted at the time when the workpieces 5 moved by the first pusher 10 have been worked to some degrees and the leading workpiece 5 pushed by the second pusher 20 does not hit the first pusher 10 in the area where the second pusher 20 advances at high conveyance speed (the pre-working fast feeding speed). The movements of pushers 10, 20 are controlled (the X1 and X2 drive means 501, 502 are controlled) so that the advancing speed of the second pusher 20 reduces down to the same low working speed of the first pusher 10 to surely keep a gap G shown in FIG. 5 just before the front edge of the leading workpiece 5 conveyed by the second pusher 20 at the high conveyance speed catches up the rear edge of the first pusher 10 moving at the low working speed.

When the first pusher 10 is finished conveying while the second pusher 20 is conveying workpieces 5 at the working speed, the first pusher 10 is retreated and returned (the fast returning) to the position (the conveyance start point) behind workpieces 5 newly supplied to the inlet side. Then the first pusher 10 conveys workpieces 5 following the second pusher 20 in the same operation as the second pusher after the fast returning as described above. In this case, the gap G is also maintained so that the front edge of the front workpiece 5 being conveyed by the first pusher 10 does not catch up with and come into contact with the rear edge of the second pusher 20 moving forward at the low working speed.

By calculating a cycle time for two pushers pushing two articles as shown in FIG. 6 for the same workpieces as for FIG. 7, a cycle time of 7.02 sec/4 workpieces=1.76 sec/workpiece was obtained. When three workpieces are worked at a time in the apparatus in accordance with the embodiment, in other words, when the two pushers pushing three workpieces respectively, the cycle time becomes 9.18 sec/6 workpieces=1.53 sec/workpiece. This value is close to a working speed of 1.5 sec/workpiece in the case of continuous feeding and continuous working of workpieces.

As a result of the embodiment of the present invention, the following effects can be obtained.

(1) The two pusher systems having pushers 10 and 20 are driven by the two drive means in such a manner that one pusher retreats and returns to the rear position of the workpices 5 sent into the inlet side of the conveyance path during another pusher advancing and pushing workpieces 5 for the working, so that the loss time is reduced and the efficiency of conveying workpieces 5 can be brought to the level close to the continuous feeding. Therefore, it is possible to increase the working capability of the working machine.

(2) In the conventional nip rollers structure for conveying workpieces to the working position, when workpiece is shorter in the conveying direction and, at the same time, a large number of workpieces exists in the conveying direction, a posture of the workpieces conveyed becomes unstable and working stability becomes defective. On the other hand, in the embodiment, the pushers 10 and 20 push either a workpiece 5 or a small numbers of workpieces 5 from behind, therefore the cumulative deformation and dimension error of the workpieces 5 does not affect the conveying, and it is possible to convey the workpieces 5 in a stable manner.

(3) Because of increasing conveyance efficiency up to the level of the continuous feeding and conveying in a stable manner, the working stability can be maintained, so that accuracy and quality of polishing can be improved in the case of the polishing machine using the grindstone 65 for example. Furthermore, the absence of stops of the working machine caused by bad positioning of the workpieces 5 contributes to improve the operation rate of working machines.

Although a polishing machine with a rotary grindstone is described in the above embodiment, it should be appreciated that the present invention may also be applied to a grinding machine with a grinding tool.

Although the embodiment of the present invention is described above, it will be apparent for those skilled in the art that the present invention is not limited to the above embodiment and variations and modifications may be made within the scope of the claims.

According to the method and the apparatus for conveying workpieces of the present invention, the two pusher systems are driven by the two drive means respectively in such a manner that one pusher retreats and returns to the rear position of at least one workpice sent into the inlet side of the conveyance path during the other pusher advancing and pushing the workpiece or workpieces, so that the loss time is reduced and the efficiency of conveying workpieces can be brought to the level close to the continuous feeding.

In the method and the apparatus, each pusher pushes at least one workpiece from behind thereof in the advancing direction. Comparing with the mechanism in which workpieces are continuously lined up and pushed in condition that a workpiece behind pushes former one, workpieces are hardly affected by the cumulative deformation and dimension error and can be conveyed in stable attitudes.

According to the working machine of the present invention, the working machine polishes or grinds workpieces fed by the above mentioned apparatus for conveying, so that the production efficiency close to continuous feeding and conveyance of workpieces can be realized and, at the same time, stability and quality of the working can be improved. Further, the absence of stops due to mal-positioning of workpieces can contribute to the improvement of the operation rate of the working machine.

1. A method of conveying workpieces comprising the:
feeding at least one workpiece to an inlet side of a conveyance path,
with a first pusher, pushing the workpiece or workpieces from a rear side in an advancing direction of the workpiece, with the first pusher being transferred substantially parallel to a conveyance direction by a first drive means, and
with a second pusher, pushing the workpiece or workpieces from the rear side in the advancing direction of the workpiece, with the second pusher being transferred substantially parallel to the conveyance direction by a second drive means, wherein, while either of the first or the second pusher moves forward to convey the workpiece or workpieces, the other pusher retreats from and returns to a position behind a workpiece or workpieces newly fed to the inlet side.

2. The method of conveying workpieces according to claim 1, wherein conveyance speed and acceleration of the first and second drive means is individually controlled.

3. The method of conveying workpieces according to claim 1, wherein the first and second pushers push a plurality of workpieces aligned continuously in the conveyance direction.

4. The method of conveying workpieces according to claim 1, wherein at least one workpiece is conveyed so that, while both the first and second pushers are moving forward, the workpiece being pushed by the pusher that is rearward does not come into contact with the pusher that is forward.

5. An apparatus for conveying workpieces, comprising:
a first pusher for pushing at least one workpiece fed to an inlet side of a conveyance path from a rear side in an advancing direction of the workpiece;
first drive means for transferring the first pusher substantially parallel to a conveyance direction;
a first transfer mechanism for transferring the first pusher to an area where the workpieces are conveyed and the area other than where the workpieces are conveyed;
a second pusher for pushing at least one workpiece fed to the inlet side of the conveyance path from the rear side in the advancing direction of the workpieces;
second drive means for transferring the second pusher substantially parallel to the conveying direction; and
a second transfer mechanism for transferring the second pusher to the area where the workpieces are conveyed and the area other than where the workpieces are conveyed.

6. The apparatus for conveying workpieces according to claim 5, wherein the first and second drive means include a servomotor.

7. The apparatus for conveying workpieces according to claim 5, wherein the first and second drive means are controlled so that, when both the first and second pushers are moving forward, the workpiece being pushed by the pusher that is rearward does not come into contact with the pusher that is forward.

8. A working machine that polishes or grinds workpieces conveyed by the apparatus for conveying workpieces according to claim 5.

9. The apparatus for conveying workpieces according to claim 5, wherein the first and second drive means include a pulse motor drive.
